(19) United States
(12) Patent Application Publication
(10) Pub. No.: US 2001/0055064 A1
(43) Pub. Date: Dec. 27, 2001

(54) Digital still camera

(76) Inventor: Tetsuya Minakami, Tokyo (JP)

Correspondence Address: McGuire Woods, Suite 1800, 1750 Tysons Boulevard, Tysons Corner, McLean, VA, 22102-4215, US

(21) Appl. No.: 09/865,481

(22) Filed: May 29, 2001

(30) Foreign Application Priority Data
Jun. 2, 2000 (JP) 166225/2000

(51) Int. Cl. H04N 5/335

(52) U.S. Cl. 348/222; 348/311; 348/333.11

(57) ABSTRACT

A digital still camera is equipped with, aside from a full frame type CCD, a sub CCD which can photograph a moving image, is small, and has less resolution and driving and process circuits thereof. The digital still camera permits preview image display on an image display device such as an LCD before main imaging. The output signal of the sub CCD is used to singly perform autofocus, white balance, photometry control, or dimmer control. A plurality of sensors corresponding to the respective functions must not be used, and the number of the driving circuits or control circuits can be reduced.

### BACKGROUND OF THE INVENTION

1. Field of the Invention

The present invention relates to a digital still camera, more specifically, to the circuit construction of a digital still camera equipped with a full frame type CCD.

2. Description of the Prior Art

In many cases, an interline type CCD (hereinafter referred to as IT-CCD) has hitherto been used as an image element (CCD) for a digital still camera. The more detailed description on the construction and operation of the IT-CCD is disclosed in, for example, CCD Camera Gijutsu, Radio Gijutsu-sha, published in 1986, or Journal of Institute of Electronics, Information and Communication Engineers, September in 1989, vol. J72-C-II, No. 9, pages 871-878.

As shown in FIG. 2, an IT-CCD is provided with alternating photosensitive portions 201 composed mainly of a photodiode, and vertical CCDs 202 as a light-shielded electric charge transfer portion. A horizontal CCD 203 (line transfer portion) is provided thereunder. The driving method therefor is as follows.

During one screen, a light is irradiated onto the photosensitive portion 201 to accumulate signal electric charges. Upon completion of this, the signal electric charges are transferred to the light-shielded vertical CCD 202 provided between the photosensitive portions 201. The signal electric charges on the vertical CCD 202 are transferred to the horizontal CCD 203 provided in the lower portion. The electric charges are transferred horizontally on the horizontal CCD 203 to be given as a signal output (Vout) from a signal read portion 204.

The IT-CCD is used as a CCD for a digital still camera by the following reasons. First, since CCD makers have manufactured IT-CCDs for a video camera in quantity and accumulate the manufacturing know-how therefor, the CCD makers can manufacture CCDs of good performance such as sensitivity. Second, use of the IT-CCD permits moving image preview display on an LCD display provided in the digital camera before the original process in which the entire or part of the CCD is driven at high speed to record a photographed image onto a recording medium. Third, the IT-CCD uses the driving method described above, which can be easily used as an image input source when an autofocus process is done.

A CCD mounted on a digital still camera having a high resolution of 6,000,000 pixels is a CCD having a construction generally called a full frame type. The detailed description on the construction and operation of the full frame type CCD (hereinafter referred to as FF-CCD) is described in, for example, CCD Camera Gijutsu, Radio Gijutsu-sha, published in 1986, or Japanese Published Unexamined Patent Application No. Sho 61-072483.

In an FF-CCD, all the photosensitive portions are constructed by vertical CCDs 302, as shown in FIG. 3. During one screen, a light is irradiated onto the vertical CCD 302 to accumulate signal electric charges. Upon completion of the exposure period, the signal electric charges are transferred sequentially a horizontal CCD 303 provided in the lower portion. The electric charges are transferred horizontally on the horizontal CCD 303 to be given as a signal output, Vout, from a signal read portion 304.

In the FF-CCD, the vertical CCD 302 itself is a photosensitive portion. The digital still camera must be equipped with a mechanical shutter, which is opened only for an exposure period, and is closed when the exposure period is completed, so as to prevent a light from entering the vertical CCD 302 during vertical transfer.

The FF-CCD is used in the digital still camera having a high resolution of 6,000,000 pixels. This is because the FF-CCD having a very large number of pixels can integrate the pixels as many as possible to the limited chip size, and increase the size of one pixel as large as possible, thereby obtaining higher sensitivity.

As is guessed from the comparison of FIG. 3 with FIG. 2, the FF-CCD can have an aperture ratio higher than that of the conventionally used IT-CCD and can, in theory, increase the aperture ratio closer to 100%. In other words, the ratio of photosensitive portion area per chip is high. Thus, it is unnecessary to perform a general operation in which a micro lens is mounted on the CCD for focusing a light onto a photodiode.

Since the FF-CCD has a high aperture ratio, when the light transmissivity of a transfer electrode present on the photosensitive portion to transfer an electric charge is sufficiently high, more light is irradiated onto the photosensitive portion, thereby generally giving a sensitivity higher than that of the IT-CCD.

In the manufacturing process, micromachining is easy, and with the equal number of pixels, the chip size can be made smaller than that of the IT-CCD.

As described previously, the FF-CCD absolutely requires shutter operation by means of the mechanical shutter for imaging due to its construction. When an FF-CCD having a very large number of pixels is used to construct a digital still camera and is driven continuously so as to image a moving image, the mechanical shutter must be operated successively at very high speed. Attempting to realize this, however, the mechanical shutter is very expensive, and the power consumption of the entire camera system is also very high.

In addition to the IT-CCD and FF-CCD, a CCD having a very large number of pixels has generally a low frame rate, and is not suitable for moving image photographing of 15 frames or more per second.

From these reasons, the liquid crystal display device of a conventional digital camera equipped with an FF-CCD does not perform checking of a photographing region before imaging (preview display), but performs only simplified display of an image after normal photographing operation (postview). The photographing region before imaging is usually checked though an optical viewfinder.

Since moving image photographing is difficult, in order to perform white balance control or photometry control which is required by successive image information, parts such as a white balance sensor and a photometry sensor, and peripheral circuits thereof are needed.

When the FF-CCD is used in a digital camera, there are generally various advantages in an image quality aspect, but it is impossible to perform preview image display by means of a color liquid crystal mounted on a recent digital camera. Various external mechanism parts such as a mechanical shutter or sensors are required. From such a reason, use of the FF-CCD is limited to a digital still camera requiring a large number of pixels or a digital still camera for business.

The inner construction of a conventional digital still camera using an FF-CCD will be described with reference to the drawings. FIG. 1 is a block diagram showing a typical inner constriction example of a conventional digital still camera equipped with an FF-CCD.

This construction example is provided with an image element 505 as an FF-CCD, a zoom lens 501, a zoom driving mechanism 510 for driving the same, an autofocus mechanism 502, an aperture mechanism 503, a mechanical shutter mechanism 504, and an analog process circuit (analog frontend) 540 for processing the output of the FF-CCD 505. The analog frontend 540 has a correlation double sampling circuit (CDS) 506 for removing a noise component from the CCD output signal, an auto gain control amplifier 507 for controlling the gain of the signal, and an A/D converter 508 for converting the CCD output signal shaped by the process to a digital signal. This construction example also has a frontend logic circuit 514 for controlling the analog front end circuits 506, 507 and 508.

This construction example is provided with an AF/AE/Zoom logic circuit 515 for controlling an optical mechanism system including an autofocus, a lens aperture and a shutter, a V driver 511, an H driver 512, and a timing signal generating circuit (TG/SSG) 513, for driving the CCD.

As described above, moving image photographing operation is difficult in the digital still camera equipped with an FF-CCD. To perform autofocus control, white balance control, and photometry control which are required by timewise successive image information, sensor parts and peripheral circuits thereof corresponding to their functions are needed.

This conventional digital still camera is provided with an AF sensor 517 for obtaining distance information required for performing autofocus operation, a dimmer sensor 518 for measuring an amount of flash light needed at night, a photometry/white balance sensor 519 for measuring the brightness and color tone (for example, ratio of three primary colors R, G and B) of an object to be photographed for performing photometry (AE) and white balance, and a control/output signal process circuit 516 for these external sensors.

The sensors 517, 518 and 519 input these output signals to one A/D converter incorporated into a sub CPU 520 for processing these output signals. The sensors 517, 518 and 519 are also considered to be provided with the respective sensor output signal process circuits aside from the sub CPU 520.

The control signal generating circuits 513, 514 and 515 are connected through a digital bus 534 to the sub CPU 520 also for performing these controls, and the sub CPU 520 commands these control circuit blocks to be operated.

A strobe mechanism 541 needed for photographing at night and a control circuit thereof 542 are provided on the digital bus 534. The digital bus 534 is a bus for mainly receiving and sending control data between the process blocks in a camera head portion, and has a less amount of data. The digital bus 534 can be slower than a main digital bus 535 for main processing.

The two buses 534 and 535 are connected through a bridge 521, and can receive and send information when an imaging start command is sent from a main CPU 526.

The digital still camera is typically provided with process blocks and so on for performing CCD signal process, compression, and write process into accumulation media. This is provided with a CCD signal process block 522 for converting an image signal from an analog frontend portion 540 to a color image, a JPEG process block 523 for performing JPEG compression of the output from the CCD signal process block 522, a memory block 528 used as a temporary buffer memory for CCD signal process and JPEG compression process and a CPU main memory, compression image data accumulation means 530 constructed by a hard disk drive, an interface logic thereof 529, image data accumulation means 532 having, as a medium, a flash memory such as a compact flash card or smart media, an interface logic thereof 531, an external output I/F 533 for outputting image data to an external PC, an LCD display 524 for displaying the image data on a digital still camera, and an interface logic thereof 525.

These signal process blocks are controlled by the main CPU 526 of the still camera, and are interconnected by the main digital bus 535.

The digital still camera is provided with a flash ROM 527 into which an execution program for the CPU 526 is written.

This conventional example is only one example, and it is also considered that, for example, the inner blocks of the digital still camera described above are interconnected by only one digital bus. In this case, the digital still camera has a more simplified construction as a camera, and can contribute to low cost as a system.

In general, the conventional digital camera equipped with an FF-CCD is provided with a plurality of sensor parts, control mechanisms thereof and control logics thereof, as information input means for optimum photographing setting.

Thus, the digital still camera equipped with a full frame type CCD has the problems as described below.

In the digital still camera equipped with a full frame type CCD, it is difficult to display a preview moving image on the liquid crystal display device before photographing. Since the full frame type CCD requires shutter operation by means of the mechanical shutter for imaging due to its construction, when a moving image is photographed by a camera equipped with this, there is needed a mechanical shutter which permits continuous operation at high speed and can operate at a precise shutter speed for each frame. This is difficult to realize in a technical view. Even if this is realized, it is thought the mechanism is complex and large and the power consumption is increased, the mechanism is not adaptable as the shutter mechanism for the digital still camera.

Since moving image photographing operation is difficult as described above, in order to perform autofocus control, white balance control, and photometry control which are required by timewise successive image information, parts such as an autofocus sensor, white balance sensor and photometry sensor and peripheral circuits thereof are needed, which is a major factor to increase the camera circuit size.

### SUMMARY OF THE INVENTION

An object of the present invention is to provide a digital still camera equipped with an FF-CCD which permits preview display on a liquid crystal display device, and reduces the number of various sensor parts and peripheral circuits thereof for use in white balance or photometry.

A digital still camera of the present invention comprises a main solid image element as a full frame type solid image element, a sub solid image element as a solid image element which has pixels fewer than that of the main solid image element and can operate at a higher frame rate than the main solid image element, and a digital image signal process circuit which processes an image signal inputted to the sub solid image element and the main solid image element.

In the digital still camera of the present invention, the digital image signal process circuit performs autofocus process, simplified image display process, white balance process, photometry control process, and dimmer control process, the image signal inputted to the sub solid image element is color signal-processed to form a color moving image, the color moving image is displayed on a simplified image display portion provided in the digital still camera.

In the white balance process of the digital still camera of the present invention, the digital still camera calculates a signal process coefficient obtained by the white balance process, and the signal process coefficient is used for processing a photographed image obtained by photographing by means of the main solid image element.

In the photometry control function of the digital still camera of the present invention, the digital still camera determines photometry data including an aperture value and shutter speed by means of the photometry control function, and performs photometry control by means of the photometry control function based on the photometry data, thereby performing photographing by means of the main solid image element.

In the dimmer control function of the digital still camera of the present invention, the digital still camera determines an amount of strobe light at strobe photographing by means of the dimmer control function, and performs photographing by means of the main solid image element using a strobe based on an amount of strobe light by the dimmer control function.

The digital still camera of the present invention is provided with an optical mechanism having an optical path change mechanism for changing or distributing the optical path of a light from a subject, the optical path change mechanism irradiating the light from the subject onto at least one of the main solid image element and the sub solid image element.

The digital still camera of the present invention is provided with an optical mechanism having an optical path change mechanism for changing or distributing the optical path of a light from a subject, and when the optical path change mechanism irradiates the light from the subject onto any one of the main solid image element and the sub solid image element, the light from the subject is shielded on the other.

In the digital still camera of the present invention, when one of the main solid image element and the sub solid image element is operated, the other is not operated.

### BRIEF DESCRIPTION OF THE DRAWINGS

FIG. 1 is an operation mechanism block diagram of assistance in explaining the operation of a conventional digital still camera using a full frame type CCD;

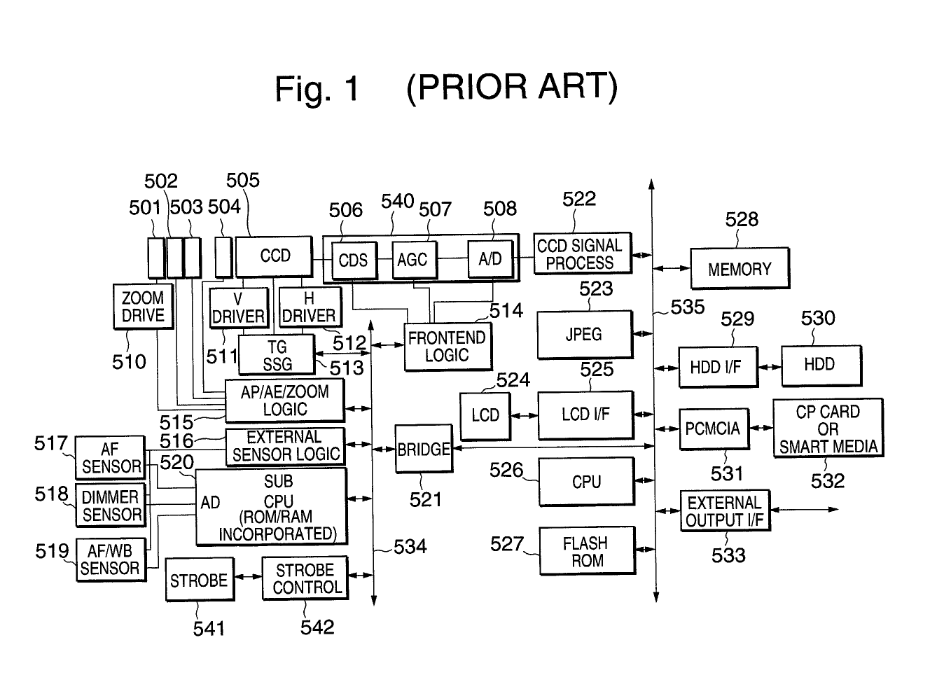

FIG. 2 is a schematic plan view of assistance in explaining an interline type CCD;

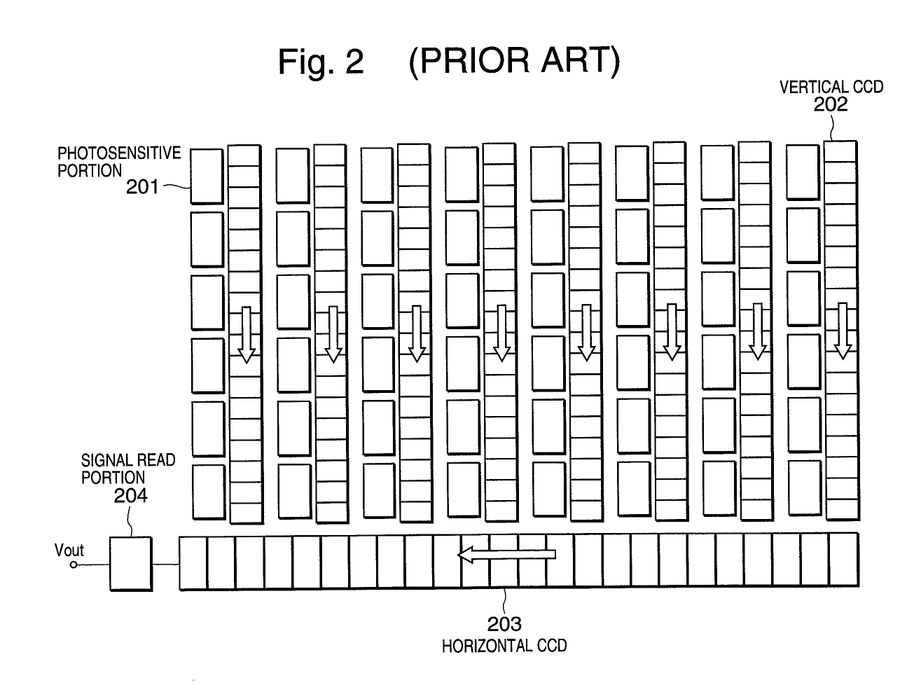

FIG. 3 is a schematic plan view of assistance in explaining a full frame type CCD;

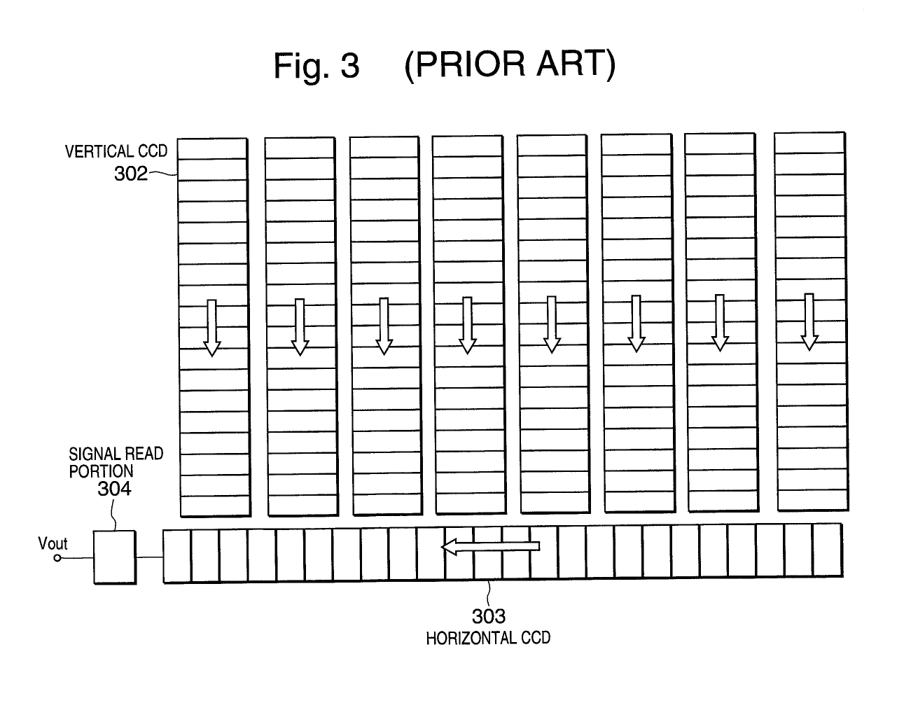

FIG. 4 is an operation mechanism block diagram of assistance in explaining the operation of a digital still camera of an embodiment of the present invention; and

FIG. 5 is a timing chart of the mechanisms of assistance in explaining the photographing operation of a digital still camera of the embodiment of the present invention.

### DETAILED DESCRIPTION OF THE PREFERRED EMBODIMENTS

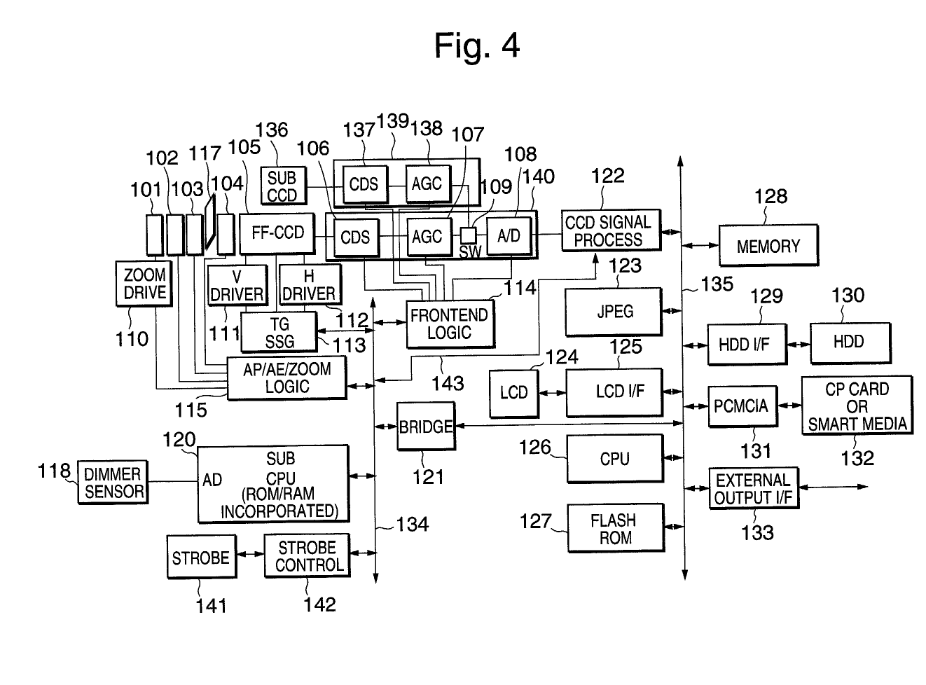

Embodiments of the present invention will be described in accordance with the drawings. FIG. 4 is a block diagram showing the inner construction example of the digital still camera of the present invention equipped with an FF-CCD. This embodiment is provided with an FF-CCD 105 used for main imaging and having a large number of pixels and high resolution, and an interline type CCD 136 which can operate at high speed enough to image a moving image of 30 frames per second. In this embodiment, the FF-CCD 105 is called a main CCD and the interline type CCD 136 is called a sub CCD. The sub CCD 136 is used for simplified image input, and its output signal is used for autofocus process, photometry control, dimmer control, and simplified image display on the LCD mounted on the camera.

Instead of the sub CCD 136, a CCD of another system or a CMOS image sensor as well as the interline type CCD can also be used when it is a color sensor image which is small and can realize a high frame rate.

A light is first irradiated from one optical system (lens), and is separated in two directions by a light distribution mechanism present partway, so as to be projected to the above-mentioned two CCDs. This is because the sub CCD 136 and the main CCD 105 having a function as a viewfinder are prevented from causing any difference in parallax or viewing angle.

The optical system is provided with a zoom lens 101, a zoom driving mechanism 110 for driving the same, an autofocus mechanism 102, an aperture mechanism 103, a mechanical shutter mechanism 104, and a mirror mechanism 117 for distributing an inputted light to the sub CCD 136 and the main CCD 105. The mirror mechanism 117 may be replaced with a mechanism such as a prism for changing or distributing an optical path.

The mechanical shutter mechanism 104 used herein may be of simplified construction which is only opened and closed by a switch. In other words, the mechanical shutter mechanism 104 of the present invention does not require high-performance shutter operation capable of precisely controlling exposure time as needed when the conventional digital still camera equipped with a full frame type CCD photographs a moving image.

The output signal of the two CCDs is analog-processed by analog process circuits (analog frontends) 139, 140. The analog frontends 139, 140 are provided with correlation double sampling circuits (CDS) 137, 106 for removing a noise component from the CCD output signal, and auto gain control amplifiers 138, 107 for controlling the gain of the signal, respectively. The analog frontends 139, 140 are also provided with an analog switch 109 for switching two signal input systems, and an A/D converter 108 for performing analog/digital conversion process of the output signal of the analog switch 109. These analog frontend circuits are controlled by a frontend logic 114.

The digital still camera is provided with an AF/AE/Zoom logic circuit 115 for controlling the optical mechanism system, a V driver 111, an H driver 112, and a timing signal generating circuit (TG/SSG) 113, for driving the CCD. FIG. 4 only shows one V driver, one H driver, and one TG/SSG for convenience. A set of the drivers and TG/SSG corresponding to each of the CCDs are present so as to drive the two CCDs 136, 105. These circuits are shared in only one logic circuit in a range to be realized, to reduce the circuit size.

The control signal generating circuits 113, 114 and 115 are connected through a digital bus 134 to a sub CPU 120 for controlling these, and the sub CPU 120 commands the control circuit blocks to be operated.

The digital still camera is provided with a strobe mechanism 141 needed at photographing at low illumination, a control circuit thereof 142, and a dimmer sensor 118 needed to measure how an amount of strobe light is needed. In FIG. 4, the dimmer sensor 118 is present independently from the sub CCD 136 having another sensor function, and its output is connected directly to the sub CPU 120 provided therein with an AD converter. However, when the sub CCD 136 has sensitive performance enough to perform dimmer process in a dark time such as at night, the sub CCD 136 may serve as the dimmer sensor, and the dimmer sensor 118 may be omitted.

The digital bus 134 is a bus for mainly receiving and sending control data between the process blocks in the camera head portion, and may be slower than a main digital bus 135 for receiving and sending large-volume image data. The two buses 134 and 135 are connected through a bridge 121, and can receive and send information when an imaging start command is sent from a main CPU 126. In general, the digital camera is provided with process blocks for performing CCD signal process, compression and write process into accumulation media.

The construction example of the digital camera of this embodiment is provided with a CCD signal process block 122 for color processing an image signal output from the A/D converter 108. This has a circuit construction which can color-process image data having different resolutions from the two CCDs in one process circuit where possible. For example, in the process of the CCD signal process block 122, a color separation process circuit, high frequency enhancement process circuit, γ process circuit and the like have different horizontal and vertical synchronizing signals to be inputted, and the circuits can be shared. When the CCD signal process block 122 processes an image signal from the sub CCD 136, its color signal output is outputted to the main digital bus 135 and at the same time, can be directly transmitted through a two-way digital bus 143 to the logic process portion 115 corresponding to autofocus, photometry process, zoom process or the like.

The digital still camera is provided with a JPEG process block 123 for performing JPEG compression of the output from the CCD signal process block 122, a memory block 128 used as a temporary buffer memory for the CCD signal process and JPEG compression process and a CPU main memory, compression image data accumulation means 130 constructed by a hard disk drive, an interface logic thereof 129, image data accumulation means 132 having, as a medium, a flash memory such as a compact flash card to smart media, an interface logic thereof 131, an external output I/F 133 for outputting image data to an external PC, an LCD display 124 for displaying the image data on the digital still camera, and an interface logic thereof 125. The respective signal process blocks are controlled mainly by the main CPU 126, and are interconnected by the main digital bus 135. The digital still camera is provided with a flash ROM 127 into which an execution program for the CPU 126 is written.

To speed up the circuit, this embodiment uses the digital bus 143 directly connecting the CCD signal process block 122 and the logic circuit 115 for performing autofocus, photometry and zoom control. This embodiment may not be provided with the two-way digital bus 143 to make the circuit simplified and inexpensive, but may receive and send an image signal and a control signal associated therewith from the main bus 135 through the bridge 121 between the buses and the digital bus 134 provided in the camera head portion to the camera head portion control logic portion 115.

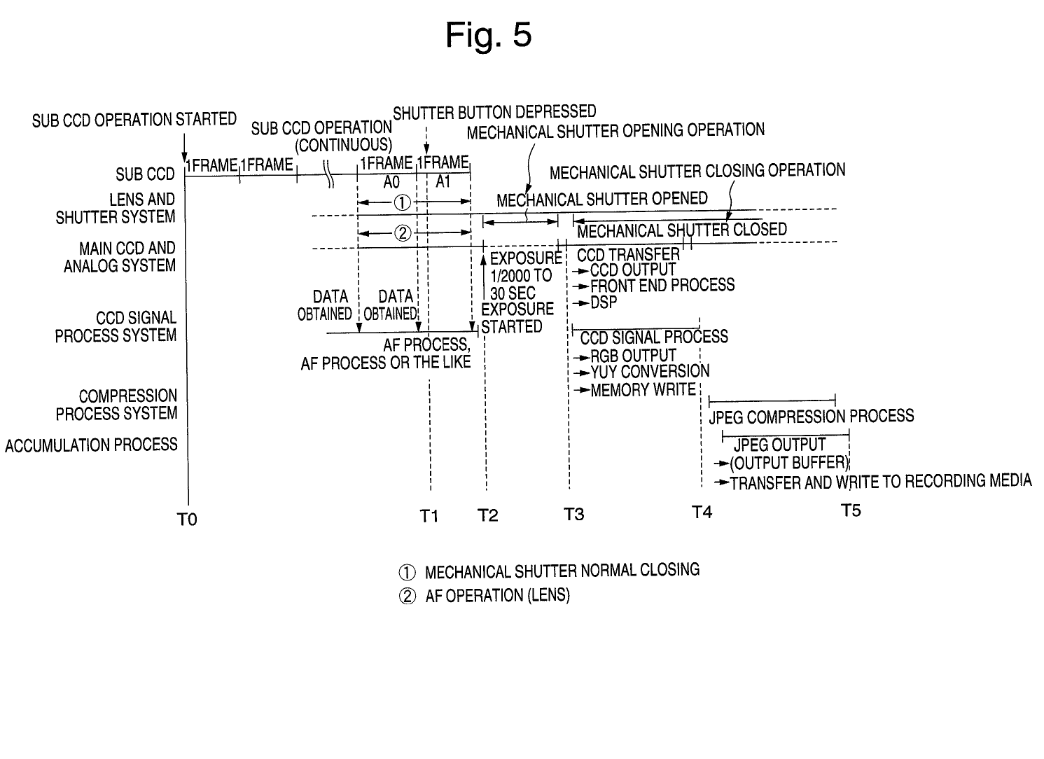

The operation of the digital still camera at imaging of this embodiment in FIG. 4 will be described with reference to the block diagram in FIG. 4 and the operation sequence diagram in FIG. 5.

When the digital still camera is turned on, the shutter button is half-pushed to perform photographing operation after the digital still camera is turned on, or the switch is turned on to perform LCD display, that is, the digital still camera is brought into the so-called “standby state before photographing” (T0 of FIG. 5), the sub CCD 136 is operated to perform preview display on the liquid crystal display device, autofocus, photometry, and white balance processes. At this time, the main CCD 105 for main image photographing is not operated, and the shutter 104 for the CCD remains closed. A constant bias voltage (electric charge removing voltage) for removing unnecessary voltage is applied to the main CCD 105. Thus, even when a light is irradiated by mistake to generate signal electric charge, the main CCD 105 produces no signal.

The output of the sub CCD 136 is noise removed by the correlation double sampling circuit 137, and is gain adjusted by the auto gain control amplifier 138, thereby being inputted through the analog switch 109 to the A/D converter 108.

Subsequently, the image signal is converted to a digital signal in the A/D converter 108, and then, the digital signal is color processed in the CCD signal process portion 122. The color process may be a process which is rather simplified and can be done at high speed, since the color process is to be used for preview image display on the LCD 124, autofocus or photometry control. The output provided by this process is sent through the digital bus 135 to the LCD interface logic 125, whereby a color moving image is displayed on the LCD 124. The color image signal is transmitted through the two-way digital bus 143 to the logic circuit 115, and is provided for autofocus and photometry process under the operation cooperating with the sub CPU 120.

The white balance process obtains a color distribution ratio optimum for main imaging using the main CCD 105 based on a signal provided by color processing the output signal of the sub CCD 136 and at the same time, determines the color distribution ratio optimum when displaying the color signal on the LCD 124. This process is done in the CCD signal process portion 122.

The result of this process is stored in a proper memory region in the digital camera, for example, in a register included in the CCD signal process portion 122. This value is calculated for each image frame imaged by the sub CCD 136, and is overwritten into the memory region to be held until main imaging by the main CCD 105. The value is provided to CCD signal process at the main imaging.

An optimum photographing parameter such as an aperture value or shutter speed by the photometry process is calculated for each image frame of the sub CCD 136 as in the white balance process, and is written into a proper memory region so as to be feedbacked and controlled to the shutter/aperture mechanism 104 as an optimum aperture value. The parameter is displayed on the LCD 124 as photographing information for the user.

Calculation process for determining an optimum amount of lens movement so that the focus matches an object (autofocus calculation process) is also done for each image frame. The result is feedbacked to the autofocus mechanism 102 in which autofocus control is done by lens driving.

When the photographer performs photographing operation such as depressing the shutter button (T1 of FIG. 5) and the imaging operation by the sub CCD 136 for one frame done at the time T1 (a frame period A1 of the sub CCD in FIG. 5) is completed, the imaging operation by the sub CCD 136 ends. Based on image data corresponding to the frame period A1, photographing parameters such as shutter speed, aperture value, and white balance coefficient optimum for the imaging operation of the main CCD 105 are calculated.

The optical mechanisms 102, 103 and 104 are operated and are set to the respective photographing parameter values obtained from the operation described above. The main CCD 105 is turned on at the time T1 to be brought into a standby state.

In addition to the above-mentioned operating procedure, it may be possible to employ an operation sequence in which the imaging operation by the sub CCD 136 and all the processes for the operation are terminated at the time T1, so as to calculate photographing parameter values based on image data for one frame by the sub CCD which has completed imaging immediately before the time T1 (image data corresponding to a frame period A0 of the sub CCD 136 in FIG. 5).

The mechanical shutter 104 for the main CCD 105 is opened to stop application of the electric charge removing voltage. Electric charge can be accumulated by photoelectric conversion to start exposure operation (time T2).

Thereafter, when the set exposure time (shutter speed) ends (time T3), the shutter 104 is closed, transfer and read operations of the electric charges accumulated on the CCD 105 are started, thereby outputting an image signal.

After completion of the exposure (time T3), the image signal output from the main CCD 105 is subjected to analog signal process by the analog frontend 140. This includes processes of noise removal by the correlation double sampling circuit 106, gain adjustment by the auto gain control amplifier 107, and input of a signal of the control amplifier 107 (analog image signal) through the analog switch 109 to the A/D converter 108 to convert the signal to a digital signal.

When the output of the image signal is completed (T4), the main CCD 105 stops the operation and the electric charge removing voltage is applied to be brought into a standby state for discharging unnecessary electric charge all the time.

Color image data of the digitalized CCD signal output is generated in the CCD signal process portion 122. The CCD signal process done at this time is usually a process for generating a high-quality color image in which noise control or suitable high frequency compensation is done. After completion of this process (time T4), compression process is done in the JPEG compression portion 123, and image data are recorded onto the hard disk 130 and the accumulation media 132 such as a compact flash card or smart media through the respective interface logics 129, 131 thereof. Resolution conversion is done for the image data, and the operation for displaying the photographed still image on the LCD 124 is performed (postview display).

After completion of a series of the imaging operations (time T5), the digital camera returns to the initial state, simplified moving image display by the sub CCD 136 and the operations as various sensors are started, or the operation of the sub CCD 136 is not started but is standby in the stop state until the shutter button is half-pushed again by the user.

In the digital camera using a full frame type CCD, the digital camera is provided with, aside from the CCD, an image sensor which can photograph a moving image, is small, and has less resolution and driving and process circuits thereof, thereby permitting preview image display on the image display device such as LCD before main imaging. The output signal of the image sensor is used to singly perform autofocus, white balance, photometry control, or dimmer control. A plurality of sensors corresponding to the respective functions must not be used, and the number of the driving circuits or control circuits can be reduced. The driving and signal processes of the full frame type CCD and the image sensor are similar to each other. These driving pulse generating circuits and signal process circuits can be shared to some extent as shown in the embodiment, and can minimum increase of the size of the inner construction of the camera.

What is claimed is:

1. A digital still camera comprising a main solid image element as a full frame type solid image element, and a sub solid image element as a solid image element which has pixels fewer than that of said main solid image element and can operate at a higher frame rate than said main solid image element.

2. The digital still camera according to claim 1, comprising a digital image signal process circuit in which an image signal inputted to said sub solid image element and said main solid image element is color signal processed to provide a color moving image and data of said color moving image are used to perform autofocus process, simplified image display process, photometry control process, and white balance process.

3. The digital still camera according to claim 2, comprising a simplified image display portion for displaying said color moving image subjected to simplified image display process by said digital image signal process circuit in order to preview display an image to be photographed before photographing.

4. The digital still camera according to claim 2, comprising a simplified image display portion in which the preview display before photographing is terminated before the photographing is started by said main solid image element so as not to display said color moving image, and after completion of the photographing by said main solid image element, the photographed image photographed by said main solid element is displayed.

5. The digital still camera according to claim 4, wherein the photographed image photographed by said main solid image element is an image compress-processed after photographing.

6. The digital still camera according to claim 1, comprising a digital image signal process circuit which calculates a signal process coefficient in the white balance process, and uses said signal process coefficient for processing the photographed image obtained by photographing by means of said main solid image element.

7. The digital still camera according to claim 1, comprising a digital image signal process circuit which determines photometry data including an aperture value and shutter speed in the photometry control process before photographing by said main solid image element, and performs photometry control based on said photometry data.

8. The digital still camera according to claim 1, comprising a digital image signal process circuit which determines an amount of strobe light at strobe photographing by the dimmer process function before photographing by said main solid image element.

9. The digital still camera according to claim 8, comprising a dimmer sensor for measuring said amount of strobe light.

10. The digital still camera according to claim 8, wherein said amount of strobe light is measured through said sub solid image element.

11. The digital still camera according to claim 1, comprising an optical path change mechanism which changes or distributes the optical path of a light from a subject, and irradiates the light from the subject onto at least one of said main solid image element and said sub solid image element.

12. The digital still camera according to claim 1, comprising an optical path change mechanism in which when the optical path of a light from a subject is changed or distributed and the light from the subject is irradiated onto any one of said main solid image element and said sub solid image element, the light from said subject is shielded on the other.

13. The digital still camera according to claim 1, comprising said main solid image element and said sub solid image element in which when one of them is operated, the other is not operated.

14. The digital still camera according to claim 11, comprising a light control logic circuit for controlling said optical mechanism, a main image analog process circuit and a sub image analog process circuit for receiving and processing the respective output signals of said main solid image element and said sub solid image element, an analog process control logic circuit for controlling said main image analog process circuit and said sub image analog process circuit, and a digital image signal process circuit for receiving and color processing the digital output signal from said main image analog process circuit and said sub image analog process circuit, said light control logic circuit and said digital image signal process circuit being interconnected.

15. The digital still camera according to claim 14, comprising, in addition to said light control logic circuit, said main image analog process circuit, said sub image analog process circuit, said analog process control logic circuit, and said digital image signal process circuit, a sub CPU for controlling said light control logic circuit and said analog process control logic circuit through a sub digital bus, and a main CPU for controlling said digital image signal process circuit through a main digital bus.

16. The digital still camera according to claim 14, wherein said light control logic circuit and said digital image signal process circuit are interconnected by a two-way digital bus provided therebetween.

17. The digital still camera according to claim 14, wherein said light control logic circuit and said digital image signal process circuit are interconnected via said main digital bus.

18. The digital still camera according to claim 14, wherein any one of said main image analog process circuit and said sub image analog process circuit includes a switch and an analog-digital converting circuit, said switch selects any one of the output signals from said main solid image element and said sub solid image element, and thereafter, the output signal selected is converted by said analog-digital converting circuit.

19. The digital still camera according to claim 1, wherein said sub solid image element is a solid image element other than a full frame type solid image element.

20. The digital still camera according to claim 19, wherein said sub solid image element is an interline type solid image element.

21. The digital still camera according to claim 19, wherein said sub solid image element is a CMOS type solid image element.
